(19) United States
(12) Patent Application Publication
(10) Pub. No.: US 2007/0035699 A1
(43) Pub. Date: Feb. 15, 2007

(54) APPARATUS, SYSTEM, AND METHOD FOR ASSOCIATING CONTEMPORANEOUS NOTES WITH PHOTOGRAPHED IMAGES USING A CAMERA SLATE

(76) Inventor: Joel V. McKee, Salt Lake City, UT (US)

Correspondence Address: KUNZLER & ASSOCIATES, 8 EAST BROADWAY, SUITE 600, SALT LAKE CITY, UT, 84111, US

(21) Appl. No.: 11/463,553

(22) Filed: Aug. 9, 2006

Related U.S. Application Data
(60) Provisional application No. 60/707,040, filed on Aug. 10, 2005.

(51) Int. Cl. G03B 21/32; G03B 17/24

(52) U.S. Cl. 352/90; 396/313

(57) ABSTRACT

An apparatus, system, and method are disclosed for associating contemporaneous notes with photographed images using a camera slate. The apparatus, in one embodiment, comprises a camera slate that includes a body having at least one substantially flat surface. The substantially flat surface includes an erasable exterior for creating a temporary note with an erasable writing device. In addition, the substantially flat surface may be viewable through a camera lens to allow a user of the camera to take a photograph of the camera slate that includes the temporary note. As a result, the image of the temporary note serve to identify and organize one or more photos stored by the camera. Furthermore, an attachment mechanism may be connected to the body for securing the body to a portable object within arm's reach of a photographer.

### CROSS-REFERENCES TO RELATED APPLICATIONS

This application claims benefit of U.S. Provisional Patent Application No. 60/707,040 entitled “Apparatus, System, and Method for Associating Contemporaneous Notes with Digitally Photographed Images Using a Digital Camera Slate” and filed on Aug. 10, 2005 for Joel McKee, which is incorporated herein by reference.

### BACKGROUND OF THE INVENTION

1. Field of the Invention

This invention relates to photography and more particularly relates to associating contemporaneous notes with digitally photographed images.

2. Description of the Related Art

Historically, professions that involve capturing multiple visual images in photographs and subsequently cataloguing or organizing those photographs have also required that a photographer maintain copious notes of the photographed material, including details relative to the specific film roll and the location of the exposed image(s). The notes typically identify the particular photographed subject and any other relevant explanations or insights conceived at the time of the image exposure. Taking detailed notes generally requires a considerable amount of time to ascertain the correct exposure and roll number, to write the notes, to organize subsequent notes, and later to match the notes with the correct photograph(s). The greater the number of photographs, the more difficult and time consuming the task becomes of maintaining, organizing, and matching the notes.

Problems further arise if the related notes get separated from the corresponding rolls of film; or if the notes are damaged or incomplete. As a result, the multiple developed images lack a contemporaneous explanation that may give meaning or context to the photographs. The photographer may then be left to rely on his or her memory to recall the details of the photographs. Recalling details may be particularly difficult if the photographed images are very similar in content or involve a large number of consecutive photographs. The photographs themselves do not typically contain specific identifying information or contemporaneous notes.

Many attempts to simplify the process of associating identifying information with a particular photograph have been made. For example, certain camera and film providers, such as Polaroid®, have produced photographs that develop rapidly and provide a writable area below the developed picture for noting details. Consequently, the photographer does not have to track the roll or exposure number and can quickly write down details directly on the photograph as soon as the photograph is released. The photographs, however, still take minutes to develop, and the method is impractical to use with multiple repeated shots. In addition, the equipment and film may be relatively expensive compared to modem digital photography equipment.

In a further attempt to associate information with a photograph, an identifier may be strategically placed for capture with an image. For example, an evidence marker with identifying information may be photographed with a piece of evidence for a crime scene investigation. Again, changing markers may be time consuming, particularly with multiple repeated shots. Furthermore, an evidence marker is not suitable for use to identify photographs wherein the content of the photograph is valued foremost above information the marker may provide, such as artistic expressions, for example.

Currently, digital photography has enabled photographers to take an even more extensive approach to photography because of the rewritable nature of digital memory devices. Photographers are generally taking more photographs of repeated subject matter because not all photographs will be developed and no film is wasted. In addition, digital memory devices typically are small, easily transported and can store relatively large amounts of images. Digital images can be easily viewed using computerized devices and are typically organized and/or stored in the order the photographs are taken. Often consecutive numbers are assigned as the file name by default to successive digital images. Still, as the number of digital images increases, the difficulty remains in creating, organizing and associating contemporaneous notes with corresponding images.

Certain digital cameras enable a user to enter a limited amount of information, such as a title, location, etc., that may be electronically associated with a digital image. Entering the information, however, generally requires the user to scroll though alphabet letters individually. Scrolling with a few select buttons tends to be excessively time consuming and impractical for associating contemporaneous notes with multiple images, especially for time sensitive shots. In addition, the space available for attaching electronic information may be limited.

From the foregoing discussion, it should be apparent that a need exists for an apparatus, system, and method that associate contemporaneous notes with digitally photographed images. Beneficially, such an apparatus, system, and method would enable photographers and other professionals to easily and efficiently capture contemporaneous notes at the time of image capture, thereby eliminating the need to associate corresponding notes at a later time. In addition, the apparatus, system, and method would be portable and easily accessible, requiring minimal set-up time. Furthermore, the apparatus, system, and method would enable grouping of a series of images and would facilitate organizing descriptive notes and context information. Thus, professionals and other individuals seeking to create a series of digital images would be able to easily create useful notes that are subsequently indexed contemporaneously with the digital images.

### SUMMARY OF THE INVENTION

The present invention has been developed in response to the present state of the art, and in particular, in response to the problems and needs in the art that have not yet been fully solved by currently available photography devices. Accordingly, the present invention has been developed to provide an apparatus, system, and method for associating contemporaneous notes with digitally photographed images that overcome many or all of the above-discussed shortcomings in the art.

The apparatus, in one embodiment, comprises a camera slate that includes a body having at least one substantially flat surface. The substantially flat surface includes an erasable exterior for creating a temporary note with an erasable writing device. In addition, the substantially flat surface may be viewable through a camera lens and the erasable exterior may be configured to visually provide a background that contrasts with the ink from the erasable writing device. As a result, the ink may be visually distinguished in a photographed image. Thus, the camera slate may be used to associate contemporaneous notes with digitally photographed images.

Furthermore, an attachment mechanism may be connected to the body for securing the body to a portable object within arm's reach of a photographer. In certain embodiments, the substantially flat surface may be viewable through a camera lens while being held by the photographer viewing the substantially flat surface through the camera lens. In select embodiments, the camera slate includes a tether connected to the attachment mechanism configured to secure the body to the portable object. The tether may be a coiled cord, a straight cord, and/or a chain, in certain embodiments. In a further embodiment, the tether is retractable and retracts the tether when not being held. In one embodiment, the portable object comprises a lens cap of the camera lens and the flat surface comprises a shape substantially similar to an exterior surface of the lens cap.

To facilitate creating temporary notes, the erasable writing device may be erasable without a fluid, in certain embodiments, and may be erased by wiping the erasable exterior with a hand, a cloth, a paper, and/or an eraser. The erasable writing device may be attachable to the body in certain embodiments. In one embodiment, a template is associated with the flat surface and provides an outline for temporary notes. A sleeve may facilitate positioning and securing an interchangeable template below the erasable exterior. Furthermore, a protective cover may cover at least a portion of the erasable exterior of the substantially flat surface.

A system of the present invention is also presented for associating contemporaneous notes with photographed images. The system may include a camera configured to create photographed images, wherein the camera is further configured to photograph a temporary note and an image, the notes comprising contemporaneous notes related to the image; a camera slate having at least one substantially flat surface, the substantially flat surface comprising an erasable exterior for creating the temporary note with an erasable writing device, and wherein the substantially flat surface is configured to be viewable through a camera lens the erasable exterior is configured to visually provide a background that contrasts with the ink from an erasable writing device wherein the ink may be visually distinguished in a photographed image; and an attachment mechanism connected to the body for securing the body to a portable object within arm's reach of a photographer. In certain embodiments, the camera is configured to group images taken in sequence with a photographed temporary note.

A method of the present invention is also presented for associating contemporaneous notes with photographed images. In one embodiment, the method includes providing a camera slate having at least one substantially flat surface; creating a temporary note on the camera slate; creating an image of the temporary note on the camera slate using a camera; creating an image of a related subject using the camera; and grouping the image of the temporary note with a subsequent image of the related subject. In certain embodiments, the camera is a digital camera and the images are digital images. As a result, the method may further include tagging the image of the temporary note.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a digital camera slate of the present invention;

FIG. 2A is a side view of a camera with a digital camera slate attached to a lens cover in accordance with the present invention;

FIG. 2B is front side view of the digital camera slate of FIG. 2A illustrating an erasable exterior for creating a temporary note in accordance with the present invention;

FIG. 3A is a perspective view illustrating one embodiment of a digital camera slate connected to a retractor with a retractable chain in accordance with the present invention;

FIG. 3B is a perspective view illustrating one embodiment of a digital camera slate connected to a belt in accordance with the present invention;

FIG. 4 is a front view of an alternative embodiment of a digital camera slate and sleeve with an attached eraser and pen in accordance with the present invention;

FIG. 5 is a schematic flow chart diagram illustrating one embodiment of a notes capture method in accordance with the present invention; and

FIG. 6 is a schematic flow chart diagram illustrating one embodiment of a contemporaneous notes association method in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

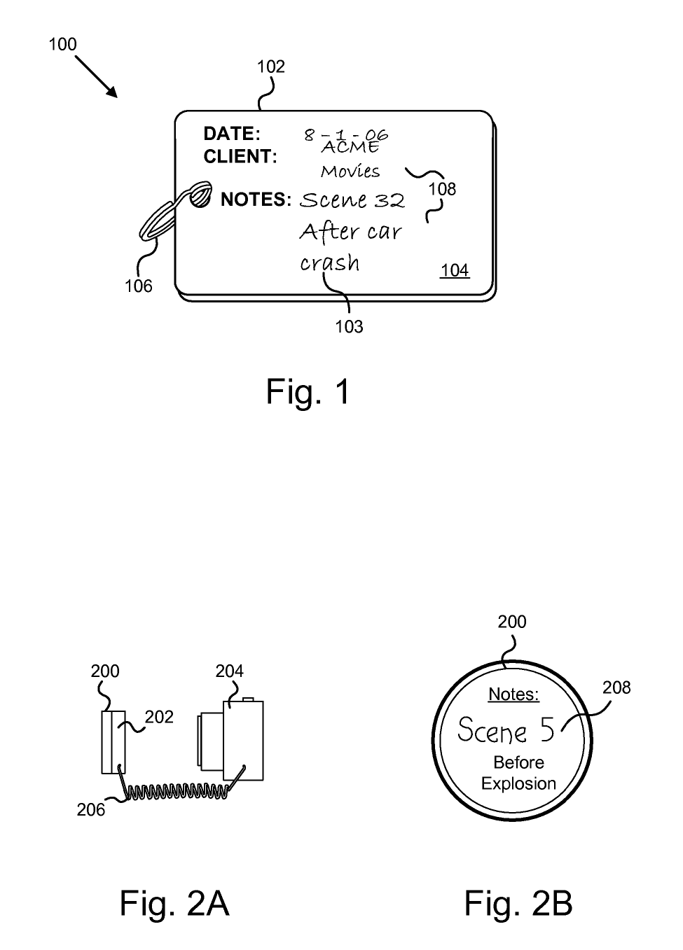

FIG. 1 depicts one embodiment of an erasable digital camera slate 100. The digital camera slate 100 as depicted includes a body 102, an erasable exterior 104, and an attachment mechanism 106. A user may quickly and easily write an erasable or temporary note 108 on the erasable exterior 104. Subsequently, a photograph or digital image may be taken of the notes 108. Preferably, the notes 108 include all erasable markings made by a user. Because digital cameras typically store digital images sequentially by date and time, a digital image taken of the temporary note 108 may precede a series of related digital images, thereby sequentially grouping the related images with the image of the note 108. Thus, the digital camera slate 100 facilitates creating a digital image of temporary notes 108. The temporary notes 108 may subsequently be digitally stored and associated with related digital images. Consequently, the notes 108 are easily made, organized, and stored with the corresponding images. As many notes 108 as are needed, or desired, may be created and organized with the photographed images. An image of a note 108 may be stored by a digital camera either before or after a series of digital images described by the note 108.

The body 102 of the digital camera slate 100, as depicted, comprises a sturdy, rigid material such as pressboard or thick cardboard with at least one substantially flat surface 103. The flat surface 103 may be covered with a plastic covering or similar transparent erasable covering that comprises the erasable exterior 104. The erasable exterior 104 preferably provides a smooth surface from which erasable ink may be easily removed with minimal agitation. The body 102 preferably comprises a rigid flat surface 103 sized to support a user writing notes 108.

In one embodiment, the digital camera slate 100 is sized to be handheld. In certain embodiments, the body 102 may be ergonomically shaped to provide one or more holes or notches to accommodate the user's fingers. In the depicted embodiment, the dimensions of the body 102 are about 3 in.×3 in. In a contemplated embodiment, the dimensions are about 3 in.×5 in. Preferably, the digital camera slate 100 is sized to be held easily in front of a digital camera such that the notes 108 are viewable through the digital camera lens. Furthermore, the erasable exterior 104 preferably enables the ink from an erasable pen to be easily distinguished from the background. Thus, notes 108 written on the digital camera slate 100 may be clearly communicated and captured in a digital image. Those of skill in the art will recognize that the digital camera slate 100 may include numerous configurations of size and composition to achieve the desired results.

In certain embodiments, the digital camera slate 100 includes an attachment mechanism 106 to secure the body 102 to an object to maintain the digital camera slate 100 in an easily accessible location. As a result, the user may easily jot a quick note 108, photograph the note 108, and continue photographing other items or scenes without worrying about the location of the digital camera slate 100. In the depicted embodiment, the attachment mechanism 106 includes a ring. The ring may be attached to another object, such as a tripod, camera bag, a piece of clothing, furniture, etc., by a tether, chain, or the like. Other attachment mechanisms 106 may include a magnet, various fasteners, hooks and loops, and the like, and may be designed to attach to specific items, such as a tripod.

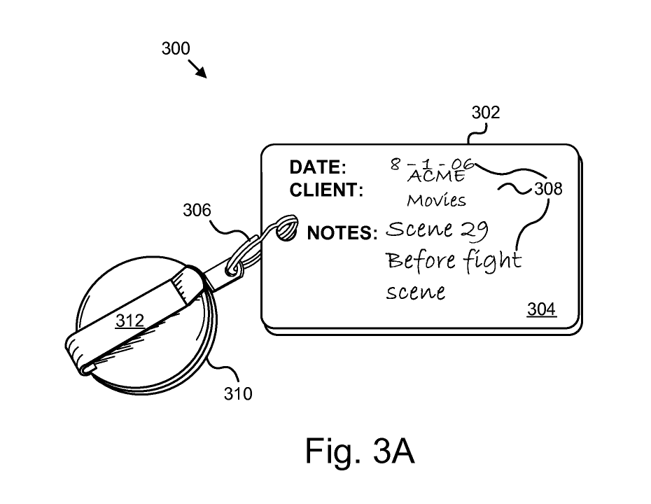

In FIG. 2A, a digital camera slate 200 is illustrated attached to a lens cap 202 of a digital camera 204. In the depicted embodiment, an attachment mechanism 206 connects the digital camera slate 200 and cap 202 to the camera 204. The attachment mechanism 206 may comprise a coiled cord as is known in the art or the like. Such a configuration may be particularly useful when a camera 204 is anchored to a shoulder strap or the like. Consequently, the user may have hands free to move objects, make a note 108, take a picture of the note 108, and resume taking pictures. The digital camera slate 200 consequently remains close at hand to the camera 204 and is accessible for quick use. Preferably, the time between writing a new note 108 and capturing the note 108 as a digital image is minimal

FIG. 2B illustrates one embodiment of the digital camera slate 200 of FIG. 2A with erasable notes 208. The user may erase all or part of the note 208 to create a new note 208 to identify a group of photographs that are to follow or that have been taken. A coiled attachment mechanism 206 may facilitate placing the digital camera slate 200 in a photographable position in front of the camera 204. The digital camera slate 200 may be alternatively attached to other objects such as a camera bag, a wristband, necklace, camera strap, tripod, or the like. Furthermore, the digital camera slate 200 may be detachably connected to another object such as a key chain, retractable cord, tether, or the like.

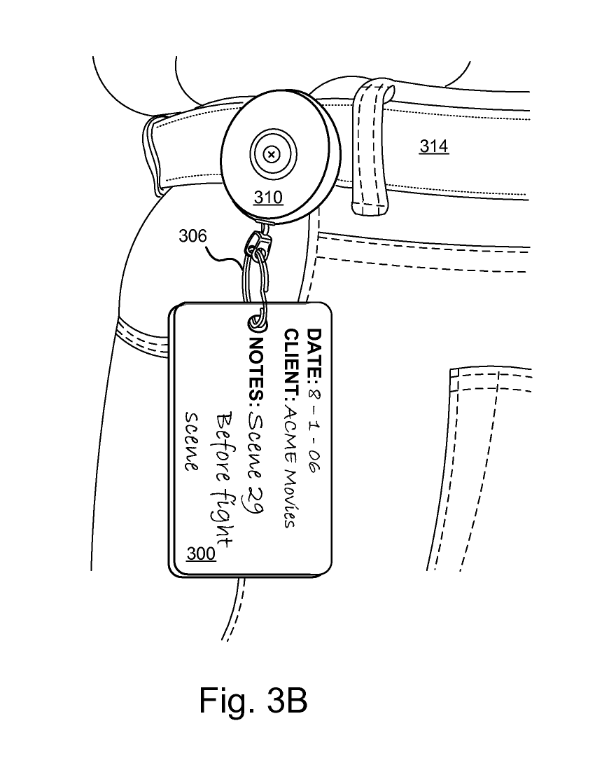

FIG. 3A illustrates one embodiment of a digital camera slate 300 attached to a retractable chain 310. The digital camera slate 300 may include a body 302, an erasable exterior 304, and an attachment mechanism 306. Notes 308 may be written on the erasable exterior 304. The retractable chain 310 may comprise a device available from KEY-BAK® and West Coast Chain MFG, Ontario, Calif. and CTL Co. Inc. Wausau, Wis. The retractable chain 310 includes a chain that coils around a spring-loaded spool. In other embodiments the retractable chain 310 includes a cord, a string, a cable, or the like. Thus, the user may extend the chain 310 connected to the body 302 of the digital camera slate 300 in order to write or take a picture of a note 308, and then the digital camera slate 300 may retract automatically with the chain 310 when the user releases the digital camera slate 300. The digital camera slate 300 remains accessible to the user at all times. In a preferred embodiment, the retractable chain 310 includes a clip 312 or other fastener for attaching the chain 310 to another object.

FIG. 3B illustrates one embodiment of a digital camera slate 300 with a retractable chain 310 fastened to a belt 314. The digital camera slate 300 consequently rests at the side of the user until the user needs the digital camera slate 300. The chain may be extended to position the digital camera slate 300 for use. Thus, the digital camera slate 300 remains readily available and accessible to the user.

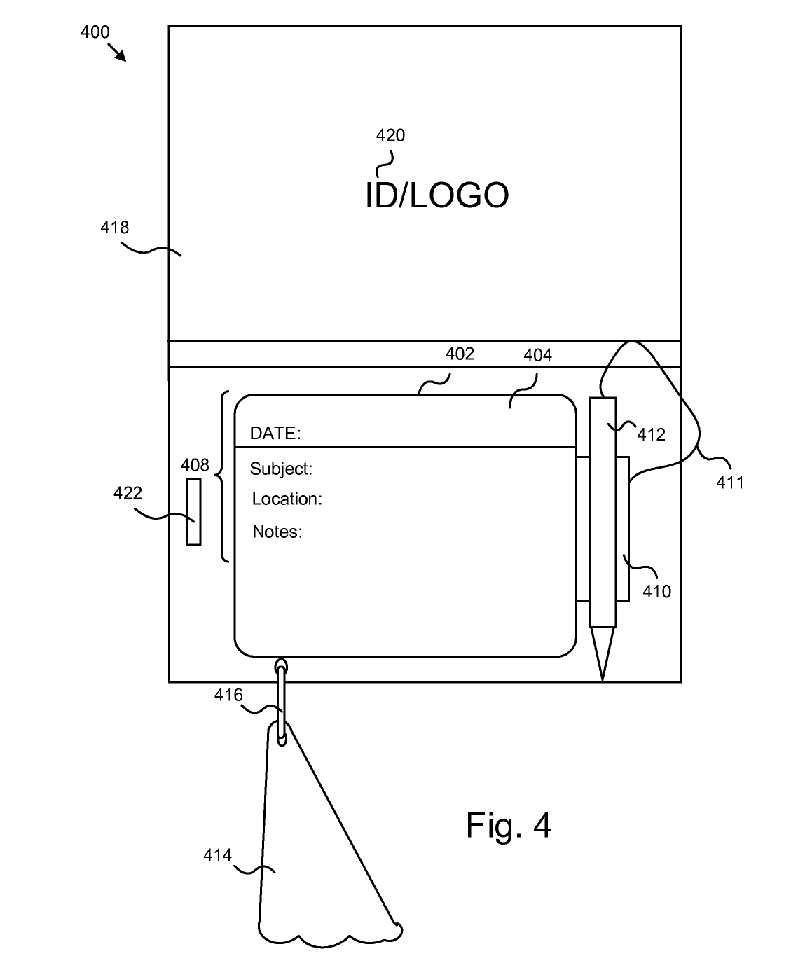

FIG. 4 illustrates an alternative embodiment of a digital camera slate 400 with a template 408. The digital camera slate 400 includes a body 402 and an erasable exterior 404. The template 408 may be formed on, beneath, or with the erasable exterior 404 and may provide an outline for temporary notes written with an erasable pen 412. Certain templates 408 may be used to identify the photographs that follow. In one embodiment, the template 408 includes a designated area for the date, location, and other contextual or explanatory information. In an application specific embodiment, such as a template 408 for film and scene development, the template 408 may include a marked area for recording a scene number or a take number.

Templates 408 may be beneficially designed to facilitate professionals in various career fields. For example, templates 408 specific to law enforcement, such as surveillance and forensics, may provide marked areas for recording specific, related information. Specialized templates 408 for other areas of application may include, but are not limited to, public safety documentation, construction and project management, landscape design, insurance claims, medical research and case documentation, scientific and field research, educational instruction, surveying, recreational planning, professional photography, etc.

In certain embodiments, the user may be able to define and/or select a specific template 408. In one embodiment, the template 408 may be removable and/or interchangeable. The body 402 may include a template attachment device (not shown) to secure the template 404 to the body 402 in certain embodiments. In one embodiment, the template 408 may be printed on a clear plastic that may adhere to the body 402 or the erasable exterior 404 of the digital camera slate 400, similar to a window sticker. The user may subsequently write on the removable clear plastic template 408 to create a note. The template 408 may be removed easily and quickly without damaging the surface of the erasable exterior 404.

In an alternative embodiment, a clear plastic covering, or erasable exterior 404, may be attached to the body 402 such that a piece of paper or the like may be placed under the plastic covering. As a result, the user may readily create a template 408 that may be inserted beneath the clear plastic covering or erasable exterior 404. In one embodiment, a sleeve or cover of the erasable exterior 404 may allow for insertion of customized templates 408. Consequently, the template 408 may be changed for various purposes or applications. Alternatively, the template 408 may be cleared or removed if no template is desired.

In a contemplated embodiment, the digital camera slate 400 may additionally include a holder 410 and/or a tether 411 for an erasable pen 412. As a result, a pen 412 may be readily accessible in addition to the digital camera slate 400. In certain embodiments, the digital camera slate 400 may further include an eraser 414 or the like to remove the erasable ink from the erasable exterior 404. In one embodiment, the eraser 414 is connected with a fastener 416.

The digital camera slate 400 may include a number of accessories. In one embodiment, the digital camera slate 400 includes a protective sleeve 418, or covering, to protect the surface of the erasable exterior 404 and/or to store other accessories. The protective sleeve 418 may include a pouch into which the slate 400 may be deposited and stored. Alternatively, the protective sleeve 418 may be pivotally attached to one edge of the digital camera slate 400. In the illustrated embodiment of FIG. 4, the protective sleeve 418 is configured similar to a checkbook cover. In such an embodiment, the sleeve 418 may be pivoted to expose the writing surface, or erasable exterior 404, for making notes when needed. In addition, the sleeve 418 may be combined with an ID tag 420, an identifying Logo 420, or the like. Furthermore, the sleeve 418 may include an opening 422 or fastener for attaching the sleeve 418 to a tether or the like. Those of skill in the art will recognize that the protective sleeve 420, attached eraser 414, pen holder 410 and the like may be alternatively configured in various embodiments and is not, therefore, limited to the illustrated embodiment. In certain embodiments, the sleeve 418 may further include a pocket or the like for storing various templates 408. Templates 408 may facilitate creating temporary notes.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

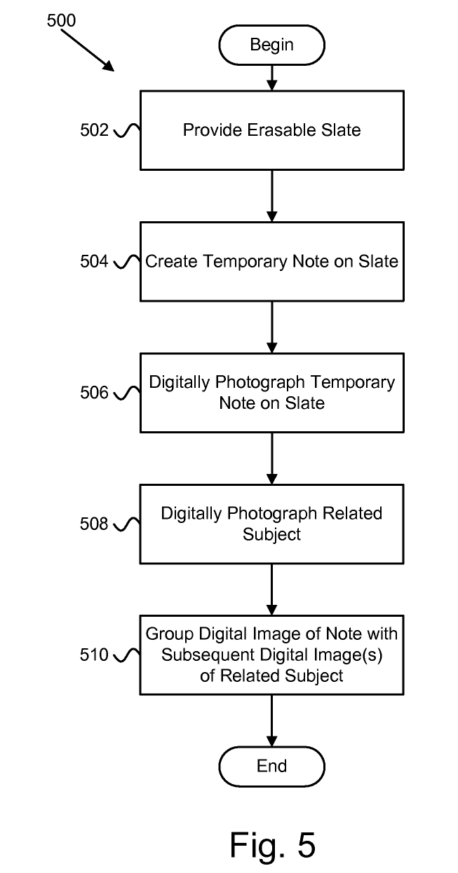

FIG. 5 illustrates one embodiment of a notes capture method 500 in accordance with the present invention. The notes capture method 500 includes providing 502 an erasable digital camera slate, creating 504 one or more temporary notes on the digital camera slate 100, digitally photographing 506 the temporary notes, digitally photographing 508 a related subject, and grouping 510 the digital image of the temporary notes with the subsequent digital image(s) of the related subject. The subsequent digital images then may be viewed in conjunction with one or more associated temporary notes, which may explain in detail information pertinent to the photographed subject. In addition, the digital images may be stored together in order on the same digital storage device, thereby eliminating the need for traditional paper notes and for organizing written notes with corresponding images later in time. The user is consequently free to concentrate on photographing images instead of tracking and cataloguing paper notes.

Alternatively, the digital photographing 508 of a related subject may occur prior to creating 504 one or more temporary notes on the digital camera slate 100 and digitally photographing 506 the temporary notes. In addition, it should be noted that the apparatus, system, and method of the present invention may be practiced using a standard film camera as well.

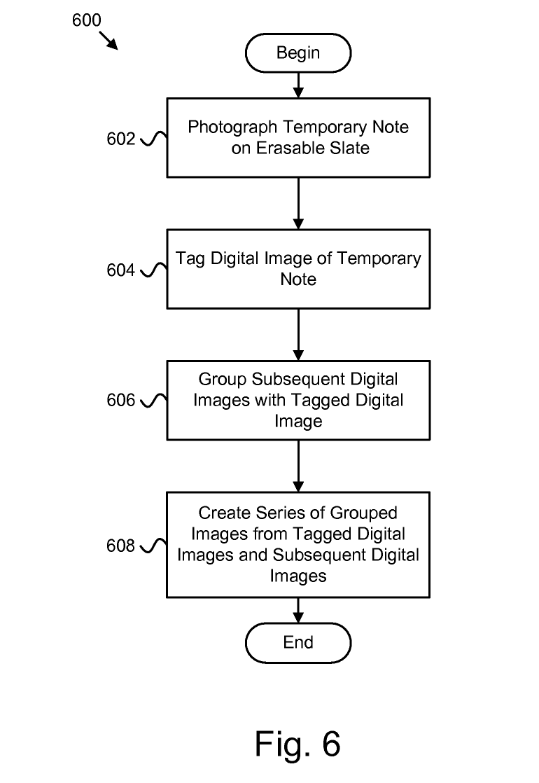

FIG. 6 further illustrates a contemporaneous notes association method 600 in accordance with the present invention. The contemporaneous notes association method 600 as illustrated includes photographing 602 a temporary note 108 on an erasable digital camera slate 100, tagging 604 the digital image of the temporary note 108 stored by the camera, grouping 606 subsequent digital images with the tagged digital image, and creating 608 a series of grouped images from the tagged digital image and subsequent digital images.

In certain embodiments, a digital camera or other computerized device may include a digital image tagging module to identify, mark, and/or select a digital image to begin a series of grouped images. In one embodiment, when a digital image is tagged, the tagging module may create a separate file folder to store the tagged digital image with subsequent digital images. The user may determine when to begin and/or terminate the grouping process in certain embodiments. As a result, when the user wants to review captured digital images, the digital images may be digitally organized into groups such as file folders with temporary notes associated with the group. The user consequently spends less time organizing notes and receives greater benefits from storing digital notes with organized digital images.

The digital camera slate provides the foundation for creating quick, usable digital notes. Thus, relevant details important at the time of origination may be easily recorded, digitally preserved, and conveniently organized with the digital images. In addition, digital images of the notes may be easily retrieved from a digital storage device. The digital camera slate is preferably reusable, portable, and erasable. A user may easily jot a quick note and take a digital picture of the note without disturbing or adjusting the camera. Typically, if the note is not ideally positioned in the frame of the camera, a user may use an image manipulation program to zoom or adjust the image of the digital note to view the note more easily.

An attachment mechanism may additionally facilitate securing the digital camera slate in an easily accessible location. Using an erasable pen with the digital camera slate enables the user to quickly create a meaningful, permanent digital message without being required to scroll through multiple letters or the like. Furthermore, the user may create and photograph as many or as few notes as desired. The notes remain with the corresponding digital images and featured subject material.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A camera slate for associating contemporaneous notes with photographed images, the camera slate comprising:
a body having at least one substantially flat surface, the substantially flat surface comprising an erasable exterior for creating a temporary note with an erasable writing device; and
wherein the substantially flat surface is configured to be viewable through a camera lens and wherein the erasable exterior is configured to visually provide a background that contrasts with the ink from the erasable writing device wherein the ink may be visually distinguished in a photographed image; and
an attachment mechanism connected to the body for securing the body to a portable object within arm's reach of a photographer.

2. The apparatus of claim 1, wherein the substantially flat surface is further configured to be viewable through a camera lens while being held by the photographer viewing the substantially flat surface through the camera lens.

3. The apparatus of claim 1, wherein the temporary note created with the erasable writing device is erasable without a fluid.

4. The apparatus of claim 1, wherein the temporary note created with the erasable writing device is erasable by wiping the erasable exterior with one of a hand, a cloth, a paper, and an eraser.

5. The apparatus of claim 1, wherein the body comprises a substantially rigid, homogenous material.

6. The apparatus of claim 1, wherein the portable object comprises a lens cap of the camera lens and the flat surface comprises a shape substantially similar to an exterior surface of the lens cap.

7. The apparatus of claim 1, further comprising a tether connected to the attachment mechanism configured to secure the body to the portable object.

8. The apparatus of claim 7, wherein the tether further comprises one of a coiled cord, a straight cord, and a chain.

9. The apparatus of claim 7, wherein the tether further comprises a retractable tether configured to retract the tether when not being held and to attach the retractable tether to the portable object.

10. The apparatus of claim 1, further comprising a template associated with the flat surface, wherein the template provides an outline for temporary notes.

11. The apparatus of claim 10, further comprising a sleeve configured to position and secure an interchangeable template below the erasable exterior.

12. The apparatus of claim 1, further comprising a protective cover configured to cover at least a portion of the erasable exterior of the substantially flat surface.

13. The apparatus of claim 1, wherein the erasable writing device is attachable to the body.

14. A system for associating contemporaneous notes with photographed images, the system comprising:
a camera configured to create photographed images, wherein the camera is further configured to photograph a temporary note and an image, the notes comprising contemporaneous notes related to the image;
a camera slate having at least one substantially flat surface, the substantially flat surface comprising an erasable exterior for creating the temporary note with an erasable writing device, and wherein the substantially flat surface is configured to be viewable through a camera lens the erasable exterior is configured to visually provide a background that contrasts with the ink from an erasable writing device wherein the ink may be visually distinguished in a photographed image; and
an attachment mechanism connected to the body for securing the body to a portable object within arm's reach of a photographer.

15. The system of claim 14, wherein the camera is further configured to group images taken in sequence with a photographed temporary note.

16. The system of claim 14, further comprising a retractable tether connected to the attachment mechanism configured to secure the body to the portable object, wherein the portable object is positioned to allow the photographer to reach the camera slate and extend the tether wherein the camera slate is viewable through a camera lens of the camera while being held by the photographer viewing the temporary note through the camera lens.

17. The system of claim 14, further comprising an attachment mechanism for attaching the erasable writing device to the camera slate.

18. The system of claim 17, wherein the erasable writing device comprises a dry erase writing device.

19. A method for associating contemporaneous notes with photographed images, the method comprising:
providing a camera slate having at least one substantially flat surface, the substantially flat surface comprising an erasable exterior for creating a temporary note with an erasable pen, wherein the substantially flat surface is configured to be viewable through a camera lens and the erasable exterior is configured to visually provide a background that contrasts with the ink from an erasable pen wherein the ink may be visually distinguished in a photographed image; and
an attachment mechanism connected to the camera slate for securing the body to a portable object within arm's reach of a photographer;
creating a temporary note on the camera slate;
creating an image of the temporary note on the camera slate using a camera;
creating an image of a related subject using the camera; and
grouping the image of the temporary note with a subsequent image of the related subject.

20. The system of claim 19, wherein the camera is a digital camera and the images are digital images and further comprising tagging the image of the temporary note.
